(19) United States
(12) Patent Application Publication
(10) Pub. No.: US 2016/0337041 A1
(43) Pub. Date: Nov. 17, 2016

(54) Polarization Independent Reflective Modulator

(71) Applicant: Futurewei Technologies, Inc., Plano, TX (US)

(72) Inventors: Yangjing Wen, Cupertino, CA (US); Fei Zhu, Coral Gables, FL (US); Yu Sheng Bai, Los Altos Hills, CA (US)

(21) Appl. No.: 15/136,396

(22) Filed: Apr. 22, 2016

Related U.S. Application Data
(60) Provisional application No. 62/162,161, filed on May 15, 2015.

(51) Int. Cl. H04B 10/532; H04J 14/06; H04J 14/02; H04Q 11/00

(52) U.S. Cl. CPC H04B 10/532; H04Q 11/0067; H04J 14/06; H04J 14/0212; H04Q 2011/0073

(57) ABSTRACT

An apparatus comprising an optical input configured to receive an optical carrier, an polarization beam splitter configured to forward a first polarized component of the optical carrier along a first light path, and forward a second polarized component of the optical carrier along a second light path, wherein the first polarized component comprises a first polarization that is perpendicular to a second polarization of the second polarized component upon exiting the optical splitter, and an optical modulator coupled to the first light path and the second light path, the modulator configured to modulate the first polarized component of the optical carrier and the second polarized component of the optical carrier.

### CROSS-REFERENCE TO RELATED APPLICATIONS

The present application claims the benefit of U.S. Provisional Patent Application No. 62/162,161 filed May 15, 2015, by Yangjing Wen, et al., and entitled, “Polarization Independent Reflective Modulator,” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

In optical access networks, carrier distribution has been considered as a promising scheme in realizing a low-cost light source for uplink signal. In carrier distribution schemes, an optical carrier signal is delivered from an optical source positioning in a central office to a remote device. The remote device then modulates uplink data onto the received optical carrier signal, and sends the modulated carrier signal back to the central office. However, current modulators employed in such systems are either temperature sensitive or only operate at a relatively low speed to avoid overheating. As a result, carrier distribution is not feasible if the remote device is uncooled and is therefore exposed to temperatures in excess of 85 degrees Celsius (° C.) and/or if the application requires high speed operation. In such cases, conventional modulators are unable to properly modulate a usable uplink signal.

### SUMMARY

In one embodiment, the disclosure includes an apparatus comprising an optical input configured to receive an optical carrier, a polarization beam splitter optically coupled to the optical input, a first light path, and a second light path, wherein the polarization beam splitter is configured to forward a first polarized component of the optical carrier along the first light path, and forward a second polarized component of the optical carrier along the second light path, wherein the first polarized component comprises a first polarization that is perpendicular to a second polarization of the second polarized component upon exiting the polarization beam splitter, and an optical modulator with a proximate end coupled to the first light path and a distal end coupled to the second light path, wherein the optical modulator is configured to modulate the first polarized component of the optical carrier and the second polarized component of the optical carrier.

In another embodiment, the disclosure includes an apparatus comprising an optical port configured to receive an optical carrier from a remote device, a polarization independent reflective modulator (PIRM) coupled to the optical port, wherein the PIRM is configured to receive the optical carrier from the optical port, split the optical carrier into a first polarized component and a second polarized component such that a first polarization of the first polarized component is perpendicular to a second polarization of the second polarized component, modulate an electrical signal onto the first polarized component and the second polarized component, and combine the modulated first polarized component and the modulated second polarized component to create a combined modulated signal.

In yet another embodiment, the disclosure includes a method comprising receiving an optical carrier from a remote device via an optical input port, splitting the optical carrier into a first polarized component and a second polarized component such that a first polarization of the first polarized component is perpendicular to a second polarization of the second polarized component, modulating an electrical signal onto the first polarized component and the second polarized component, and combining the modulated first polarized component and the modulated second polarized component to create a combined modulated signal.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a polarization independent reflective modulator (PIRM).

FIG. 2 is a schematic diagram of an embodiment of a cloud radio access network (CRAN) configured to employ a PIRM.

FIG. 3 is a schematic diagram of an embodiment of a CRAN configured to employ wavelength division multiplexing via a plurality of PIRMs.

FIG. 4 is a schematic diagram of an embodiment of a datacenter network configured to employ PIRMs.

FIG. 5 is a schematic diagram of an embodiment of a silicon waveguide based PIRM.

FIG. 6A is a top view of an embodiment of an external polarization beam splitter coupler (EPSBC) based PIRM.

FIG. 6B is a cross sectional view of the embodiment of the EPSBC based PIRM.

FIG. 7 is a schematic diagram of an embodiment of a grating coupler based PIRM.

FIG. 8 is a schematic diagram of an embodiment of a baseband unit (BBU) for use in a CRAN employing PIRMs.

FIG. 9 is a schematic diagram of another embodiment of a BBU for use in a CRAN employing PIRMs.

FIG. 10 is a schematic diagram of an embodiment of a Network Element (NE) configured to operate in a network employing PIRMs.

FIG. 11 is a flowchart of an embodiment of a method of PIRM based modulation.

FIG. 12 is a graph of power penalty versus modulator location deviation tolerance for an embodiment of a PIRM.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

In cloud radio access networks (CRANs), traffic rate requirements may necessitate the use of fiber connections between remote radio units (RRUs) and baseband units (BBUs). In such a network, an optical transponder may be placed at a tower which is connected to the radio unit via common public radio interface (CPRI). In this kind of environment, the transponder may be subjected to high temperatures in excess of 85° C. At such a high temperature, uncooled lasers may not operate properly and/or may not provide sufficient power budget, particularly at high-speed modulation rates, for example, greater than or equal to 25 gigabits per second (Gbps). Cooling lasers using thermoelectric cooling (TEC) significantly increase power consumption. It is thus desirable to eliminate the laser at the RRU site, to deliver the optical carrier from the BBU, and to modulate data at the RRU via an optical modulator. However, optical modulators (such as Mach-Zehnder modulators) that can be operated in uncooled conditions are dependent on the polarization orientation of the incoming optical carrier, which varies randomly after fiber transmission and is difficult to track.

Disclosed herein are embodiments of a polarization independent reflective modulator (PIRM). The PIRM is operable in high temperature environments and eliminates the polarization dependence of an optical carrier coming from an optical medium such as a fiber. The PIRM employs a polarization beam splitter/combiner to split the incoming optical carrier into two perpendicular polarization components, sometimes referred to herein as transverse electric (TE) and transverse magnetic (TM) components, and forwards each of the polarization components along a different light path. One of the polarization components is then rotated to be parallel to the other component. For example, the TM component is rotated, resulting in a second TE component. After rotation, both polarization components share the same polarization, which allows a polarization sensitive modulator to operate on both components. The two polarization components are input into an optical modulator from opposite ends for substantially simultaneous modulation. The modulated components then swap light paths and return to the polarization beam splitter/combiner for combination into a complete modulated signal. Multiple PIRMs may be coupled to a multiplexer to allow each PIRM to operate on a different wavelength (λ), allowing the PIRMs to support wavelength division multiplexing. In a CRAN network, the PIRM(s) are positioned in one or more RRUs, each corresponding to a BBU comprising the optical source (e.g. laser). In a datacenter network, the PIRMs may be positioned in server rack, for example in the servers or in a top of rack (ToR) element. PIRMs may also be positioned in end of row (EOR) switches, which allows a single optical source/laser to provide carriers for a plurality of sever rows.

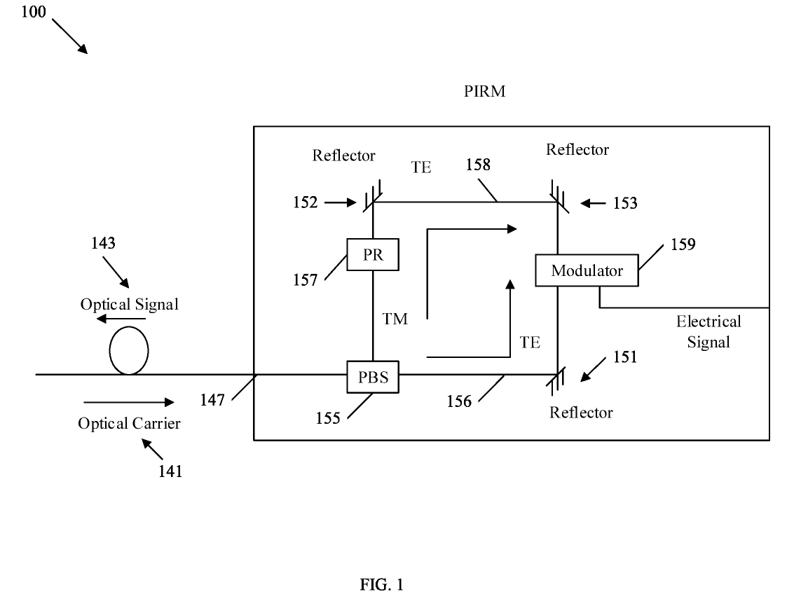

FIG. 1 is a schematic diagram of an embodiment of a polarization independent reflective modulator (PIRM) 100. The PIRM 100 comprises a polarization beam splitter (PBS) 155 coupled to a modulator 159 via a light path 156 and a light path 158, sometimes generally referred to herein as a first/second light path. Reflectors 151, 152, and 153 are positioned along the light paths 156 and 158 to control the direction of light traversing the light paths 156 and 158. The PIRM 100 further comprises an optical input 147 for receiving an optical carrier 141 and transmitting an uplink signal 143 over an optical medium, such as an optical fiber, etc.

The PBS 155 may be any device configured to split an optical carrier into two polarized light beams and output the polarized light beams along light paths 158 (in a clockwise direction) and 156 (in a counter-clockwise (CCW) direction), respectively. Specific examples of PBS 155 are discussed further in various embodiments below. The PBS 155 receives an optical carrier 141 via an optical input 147, which may be a port, an optical waveguide, etc. The optical carrier 141 may be received from a remote apparatus comprising a continuous wavelength laser or similar optical source. The optical carrier 141 may be linearly polarized upon leaving the remote device, but may become elliptically polarized during transmission to the PIRM. For example, the optical carrier may comprise a single optical component, such as a TE polarization, but portions of the optical carrier may rotate into a TM polarization when traversing an optical fiber. The PBS 155 sends the light beam of the received optical carrier 141 containing the TE polarization portion via light path 156. The PBS 155 sends the light beam of the received optical carrier 141 containing the TM polarization portion via light path 158. When light beams leave the PBS 155, light in clockwise direction contains whatever portion of the optical carrier that comprises a polarization that is perpendicular to light beam in CCW direction.

The light paths 156 and 158 may comprise any medium with a refractive index suitable for communicating an optical signal, for example an optical waveguide, glass, air, etc. A polarization rotator (PR) 157 is positioned along light path 158. PR 157 may be any device configured to rotate the polarization of a polarized light beam by a specified angle, such as a Faraday rotator or a mode converter. Specifically, PR 157 rotates the polarization of light beam in the clockwise direction so that the light beam becomes polarized in parallel with the light beam in CCW direction (e.g. a 90 degree rotation). In other words, PR 157 converts the TM polarization of light beam in clockwise direction into a TE polarization so that the light in both directions comprise the same polarization. In the example embodiment shown in FIG. 1, the PIRM 100 comprises reflectors 151, 152, and 153. The reflectors 151-153 may be any materials/devices with refractive index sufficient to alter the direction of light beam in clockwise and CCW directions along the light paths 156 and 158, as shown.

Modulator 159 may be any device capable of modulating an electrical signal onto an optical carrier. Specifically, modulator 159 is a high speed lumped modulator where the modulator active length may be less than 2 millimeters (mm). Modulator 159 may be implemented as any silicon waveguide based modulator, a single lumped modulator, an Mach-Zehnder modulator (MZM), an Inphase Quadrature (IQ) modulator, an electro-absorption modulator, a micro-ring resonator based modulator, etc. Modulator 159 comprises a proximate end and a distal end coupled to light path 156 and light path 158, respectively. Modulator 159 is configured to receive the light beam in CCW direction at the proximate end and receive the light beam in clockwise direction at the distal end. As light beams in both directions pass through modulator 159, the modulator 159 substantially simultaneously modulates the electrical signal onto both light beams. Modulator 159 may be selected to be temperature insensitive and polarization sensitive. However, because the TM component has been rotated into a TE polarization by PR 157, both light beams share the same polarization. Accordingly, modulator 159 can modulate both light beams despite the light beams being received from opposite directions. To ensure the same portion of optical carrier 141 is substantially simultaneously modulated by modulator 159 (e.g. no signal skews), light paths 156 and 158 should be approximately the same length, placing the modulator 159 in the center of the optical circuit. Modulator 159 position may vary slightly (e.g. 0.5 picoseconds (ps), 1 ps, etc. difference between light path travel times) without significantly impacting modulation, as shown in FIG. 12 below.

Modulated light beams exit the modulator 159 from opposite ends, such that the modulated light beam in the CCW direction leaves the distal end and the modulated light beam in clockwise direction leaves the proximate end. The modulated light beam in the clockwise direction continues clockwise around the optical circuit via light path 156 and the modulated light beam in the CCW direction continues counter-clockwise around the optical circuit via light path 158. The modulated light beams in both directions are both received back at PBS 155 and combined into a combined modulated optical signal 143, which is then transmitted upstream across the same fiber transporting the optical carrier 141.

By employing the optical circuit of PIRM 100, the dependence of polarization on incoming optical carrier is eliminated. Accordingly, PIRM 100 allows the laser/optical source to be moved to a remote apparatus while allowing modulation to occur in a high temperature environment by a temperature insensitive modulator. Further, it should be noted that first component, second component, TM, and TE are employed herein as labels for purposes of discussion, but may be alternated in some embodiments without affecting the operation of PIRM 100. Further, PR 157 may instead be positioned in light path 156 with the PBS 155 TM polarization output connected to path 156, but with no change in the combined modulated signal 143 output from the PIRM.

It should be noted that the modulator 159 can be designed to be located at the middle of an optical path comprising both light path 156 and light path 158. Practical fabrication may have some tolerance. Assuming that the incoming optical carrier 141 has a rotation angle θ relative to the TE polarization of PBS 155, the output optical field of the PIRM can be expressed as:

$${\vec{E}}_{out} ( t ) = {\hat{e}}_{TE} {E}_{in} f ( t - \frac{T}{2} - δ ) cos θ + {\hat{e}}_{TM} {E}_{in} f ( t - \frac{T}{2} + δ ) sin θ \qquad ( 1 )$$

where Eₒᵤₜ is the PIRM 100 output optical field as a function of time (t), Eᵢₙ is the amplitude of the PIRM 100 input optical field, f(t) is the modulation waveform function of modulated data over time, T is the delay of the PIRM 100 optical path (e.g. light path 156 plus light path 158), δ is the modulator 159 location deviation away from the optical path center, ê_{TE} and ê_{TM} are the unit vectors of TE and TM polarizations, respectively, and ê_{TE}·ê_{TE}=1, ê_{TM}·ê_{TM}=1, ê_{TE}·ê_{TM}=0. The total output power is expressed as:

$${P}_{out} ( t ) = {\vert {\vec{E}}_{out} ( t ) \vert}^{2} = {\vert {E}_{in} \vert}^{2} {f}^{2} ( t - \frac{T}{2} - δ ) {cos}^{2} θ + {\vert {E}_{in} \vert}^{2} {f}^{2} ( t - \frac{T}{2} + δ ) {sin}^{2} θ \qquad ( 2 )$$

where Pₒᵤₜ is the total output power of the PIRM 100 as a function of time, and all other variables are as defined in Equation 1.

If the modulator location deviation away from the optical path center, δ is 0, then the output power of the PIRM 100 is:

$${P}_{out} ( t ) = {\vert {\vec{E}}_{out} ( t ) \vert}^{2} = {\vert {E}_{in} \vert}^{2} {f}^{2} ( t - \frac{T}{2} ) \qquad ( 3 )$$

where all variables are as defined in Equations 1-2. Equation 3 shows that the total output of PIRM 100 is independent to the polarization state of the incoming optical carrier.

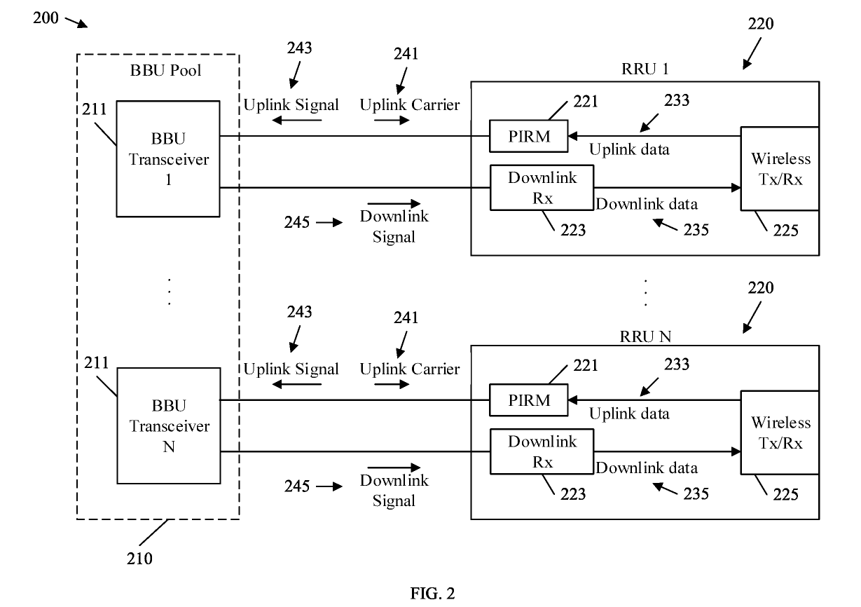

FIG. 2 is a schematic diagram of an embodiment of a cloud radio access network (CRAN) 200 configured to employ a PIRM 221, which may be similar to PIRM 100 or any other PIRM embodiment disclosed herein. CRAN 200 comprises a pool of BBUs each comprising a BBU transceiver (Tx/Rx) 211. Each BBU Tx/Rx 211 is coupled to a corresponding RRU 220, for example, via one or more optical fibers. Each RRU 220 comprises a wireless Tx/Rx 225, a PIRM 221, and a downlink receiver (Rx) 223. Each RRU 220 communicates with mobile nodes (MNs) via a wireless interface, such as an Long Term Evolution (LTE) interface, LTE advanced interface, etc., across the wireless Tx/Rx 225. Each BBU Tx/Rx 211 sends an optical downlink signal 245 to the corresponding downlink Rx 223 for transmission to the corresponding MN. The downlink signal 245 is converted to electrical downlink data 235 and transmitted to the MN via wireless Tx/Rx 225. The MN transmits corresponding uplink data 233 via wireless Tx/Rx 225. RRU 220 does not comprise an optical source (e.g., a laser, Light Emitting Diode (LED), etc.). The BBU Tx/Rx 211 transmits an optical uplink carrier 241 downstream to the RRU 220. The RRU 220 employs the PIRM 221 to modulate the uplink data 233 from the MN onto the uplink carrier 241 to create an optical uplink signal 243. The uplink signal 243 is then returned to the BBU Tx/Rx 211 via the optical fiber, for example across the same fiber as the uplink carrier 241. The uplink signal 243 can then be separated from the uplink carrier 241 at the BBU Tx/Rx 211.

A BBU pool is any grouping of BBUs, for example positioned in a wireless base station, equipment room, etc., for processing baseband signals. Each BBU may comprise one or more BBU Tx/Rxs 211, each of which is responsible for communicating with a corresponding RRU 220. The BBU Tx/Rxs 211 each comprise one or more optical sources, such as continuous wave lasers. The optical sources transmit polarized optical carriers toward the RRUs 220. The BBU Tx/Rxs 211 each comprise modulators to modulate a downlink signal 245 onto a downlink optical carrier provided by a downlink optical source. The BBU Tx/Rxs 211 also each comprise a receiver to receive the uplink signal and an optical splitter/combiner or optical circulator to separate the uplink signal 243 from the uplink carrier 241 (provided by an uplink optical source) transmitted over the optical fiber. PIRMs may also be employed on the BBUs to eliminate the polarization dependence of the optical carriers.

The BBU pool may be arranged in a star-topology as shown such that the CRAN 200 comprises a BBU pool and multiple RRUs 220. The star-topology based CRAN 200 can be extended to a CRAN 200 with tree-topology or other architectures. A tree-topology may save fiber length but may suffer from signal loss due to the introduction of power splitters in the optical link.

The RRUs 220 each comprise a wireless Tx/Rx 225, which may be any antenna or antenna array configured to wirelessly communicate with MNs via an LTE, LTE advanced, or other wireless system. RRUs 220 each further comprise a downlink Rx 223 coupled to the wireless Tx/Rx 225. The downlink Rx 223 may be any optical receiver configured to detect an optical signal received over a fiber, for example a Positive-Negative (P-N) junction, a photodiode, or similar structure. The RRUs 220 each may further comprise processor(s), memory, cache, etc. to control the wireless Tx/Rx 225 and cause the downlink data 235 from the downlink Rx 223 to be transmitted on specified wireless bands at specified times. The RRU 220 does not comprise an optical source, so the uplink carrier 241 is provided by the BBU Tx/Rx 211. The PIRM 221 modulates uplink data 233 from the wireless Tx/Rx 225 onto the uplink carrier 241 to create the uplink signal 243, which is returned to the BBU Tx/Rx 211. The fiber length between the BBU Tx/Rx 211 and the RRU 220 can range from tens of meters to tens of kilometers resulting in significant random alteration of the polarization of the uplink carrier while traversing the fiber. However, the PIRM 221 eliminates the polarization dependence and modulates the uplink carrier 241 regardless of temperature. By employing the PIRM 221, the RRU 220 can be located on a tower in an uncooled environment. Further, the RRU 220 can be produced more cheaply as no laser or similar optical source is required.

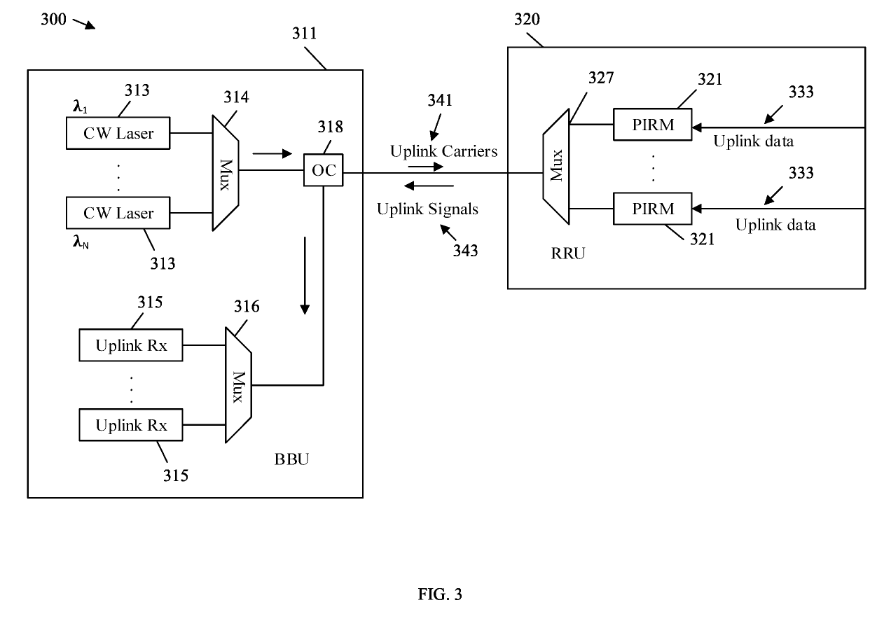

FIG. 3 is a schematic diagram of an embodiment of a CRAN 300 configured to employ wavelength division multiplexing via a plurality of PIRMs 321, which may be substantially similar to PIRM 100 or any other PIRM embodiment disclosed herein. CRAN 300 comprises a BBU 311 and an RRU 320, which may be substantially similar to a BBU Tx/Rxs 211 and an RRU 220, respectively, but are configured to communicate via wavelength division multiplexing (WDM).

The BBU 311 comprises a desired number (N) of continuous wavelength (CW) lasers 313. Each CW laser 313 is an optical source and transmits an uplink carrier 341 comprising a wavelength (λ), resulting in uplink carriers 341 of λ₁ to λ_{N}. BBU 311 further comprises an optical multiplexer (Mux) 314, which may be any device capable of combining a plurality of optical carriers/signals of different wavelength into a single fiber and/or capable of splitting multiple wavelengths from a single fiber into a plurality of fibers according to wavelength. Mux 314 is configured to multiplex uplink carriers 341 of λ₁ to λ_{N} into a single fiber for transmission to RRU 320.

RRU 320 comprises a Mux 327 that substantially similar to Mux 314 and is configured to separate the multiplexed carriers 341 λ₁-λ_{N} to different ports based on wavelength. RRU 320 further comprises N PIRMs 321 coupled to Mux 327. Each PIRM 321 is substantially similar to PIRM 221, but is allocated to a particular wavelength. Accordingly, RRU 320 receives N uplink data 333 signals, which are substantially similar to uplink data 233 signals. Each uplink data 333 signal is modulated to a specified uplink carrier 341 λ at a corresponding PIRM 321 resulting in uplink signals 343 λ₁-λ_{N}. Uplink signals 343 are combined by the Mux 327 into a single uplink port for transmission back across the fiber to BBU 311.

The BBU 311 further comprises an optical coupler (OC) 318 coupled to Mux 314. The OC 318 may be any device capable of separating/combining the uplink carriers 341 headed in the downstream direction from/with the uplink signals 343 headed in the upstream direction across a single fiber. For example, an OC 318 may be an optical coupler, an optical circulator, or other optical splitting/combining device. The OC 318 is also coupled to a Mux 316. The OC 318 forwards the combined uplink carriers 341 from Mux 314 in toward the RRU 320 and forwards the combined uplink signals 343 from the RRU 320 toward Mux 316. Mux 316 is substantially similar to Mux 314 and is configured to split the combined uplink signals 343 into individual signals before forwarding each uplink signal 343 to a corresponding uplink Rx 315. The uplink Rxs 315 are each substantially similar to a downlink Rx 223, but are configured to receive and interpret a corresponding uplink signal 343 at a corresponding wavelength. Accordingly, N uplink Rxs 315 are employed to receive uplink signals 343 λ₁-λ_{N}.

It should be noted that an optical amplifier may be placed between the OC 318 and Mux 316 or between OC 318 and the transmission fiber. Examples of optical amplifiers include, but are not limited to, semiconductor optical amplifiers (SOAs), reflective-type SOAs (RSOAs), and erbium doped finer amplifiers (EDFAs). Further, wavelength division multiplexing may be in different forms, such as coarse WDM, local area network (LAN)-WDM, or dense WDM, and may be operated at different wavelength bands, for example, the O-band, C-band, and L-band optical bands. Further, it should be noted that only the uplink channel is shown in FIG. 3 for clarity. However, a downlink channel may be configured in a similar manner to the uplink channel (e.g. N downlink lasers and a Mux in the BBU 311 and a corresponding Mux and N downlink receivers at the RRU 320). By employing CRAN 300, an RRU 320 can employ wavelength division multiplexing to communicate a plurality of uplink signals without comprising a laser or other optical source. By employing a plurality of PIRMs 321, the RRU 320 can be produced cheaply and operate in a high temperature environment while employing a single fiber for a plurality of uplink signals 343.

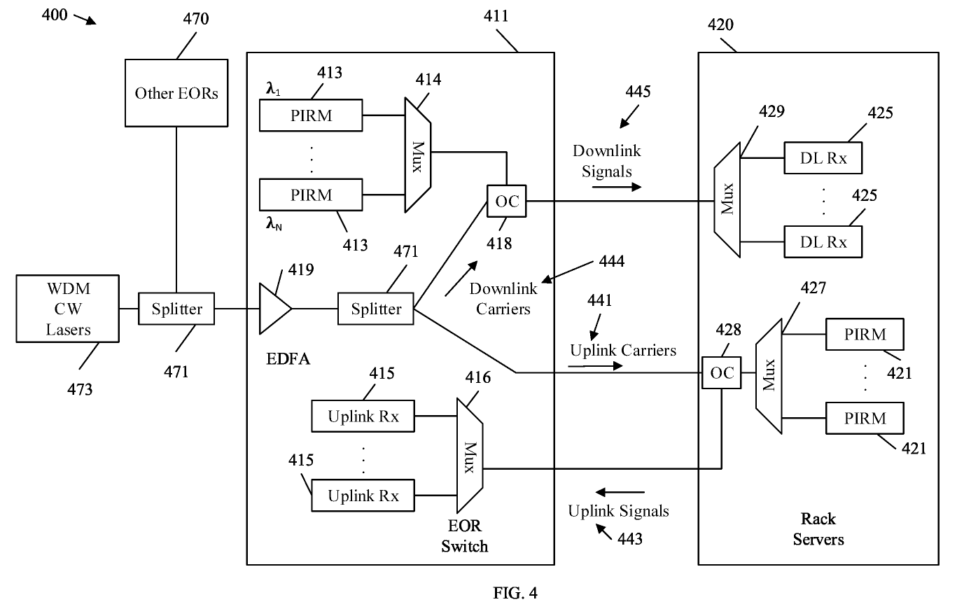

FIG. 4 is a schematic diagram of an embodiment of a datacenter network 400 configured to employ PIRMs 413 and 421, which may be substantially similar to PIRM 100 or any other PIRM embodiment disclosed herein. Datacenter network 400 comprises a plurality of rack servers 420, which are hardware devices that provide services to clients, for example by providing applications, operating software, virtualization, cloud computing, etc. Each rack of rack servers 420 may be interconnected by a Top of Rack (TOR) switch. The TOR switches/Rack servers may be organized in rows, such that each row is connected to an EOR switch 411 or 470. The EOR switches 411 or 470 are then coupled to a core network, allowing the rack servers 420 to communicate with clients via the EORs 411/470 and the core network. In an embodiment, EOR switches 411 and 470 and rack servers 420 each comprise PIRMs 413 and 421, respectively, allowing WDM CW lasers 473 to provide optical carriers for a plurality of servers, a plurality of server racks, and/or a plurality of server rows in the datacenter network 400.

The WDM Lasers 473 may be any optical light source that transmits a plurality of optical carriers at a plurality of wavelengths, and may be substantially similar to CW lasers 313. Optical carriers from the WDM Lasers 473 are forwarded to a splitter 471, which is any device configured to split an optical carrier into multiple portions, for example into multiple copies of the same group of optical carriers with reduced power/luminance. The optical carriers exit the splitter 471 and are forwarded to EOR switch 411 and other EOR switches 470, which are substantially similar to EOR switch 411, but are not shown in detail for clarity of discussion.

EOR switch 411 is any device capable of connecting other devices by performing packet switching across an optical network. The optical carriers are received at the EOR switch 411 and forwarded through an EDFA 419 to amplify the power/luminance of the optical carriers. In some embodiments, other amplifiers such as SOAs may be employed in addition to or in place of the EDFA 419. The amplified optical carriers are forwarded through an additional splitter 471 resulting in a set of uplink carriers 441 and a set of downlink carriers 444. The uplink carriers 441 are forwarded to the rack servers 420 and the downlink carriers 444 are forwarded for modulation. EOR switch 411 comprises PIRMs 413, which are similar to PIRMs 321 and are interconnected by a Mux 414, which is substantially similar to Mux 314. EOR switch 411 further comprises an OC 418, which is substantially similar to OC 318. The downlink carriers 444 pass through the OC 418 and are forwarded to Mux 414. Mux 414 splits the downlink carriers 444 into N carriers by wavelength and forwards them to the corresponding PIRMs 413 for modulation. PIRMs 413 modulate a plurality of downlink data onto the downlink carriers 444 to create downlink signals 445, which are then combined by the Mux 414 for transmission to the rack servers 420 via OC 418.

The rack servers 420 comprise a Mux 429 and downlink (DL) Rxs 425, which are substantially similar to Mux 316 and uplink Rxs 315, respectively, but configured to convey downlink signals 445. Mux 429 splits the downlink signals 445 by wavelength and forwards them to the DL Rxs 425 to be received and converted to electrical downlink data. The rack servers 420 also comprise an OC 428, a Mux 427, and PIRMs 421, which are substantially similar to OC 418, Mux 427, and PIRMs 421, respectively. The uplink carriers 441 are forwarded to Mux 427 via the OC 428. Mux 427 splits the uplink carriers 441 by wavelength and forwards them to the corresponding PIRMs 421 in a manner similar to Mux 414 and PIRMs 413. The PIRMs 421 modulate uplink data onto the uplink carriers 441 to create uplink signals 443, which are combined by the Mux 427 for transmission back upstream to the EOR switch 411. The EOR switch 411 receives the uplink signals 443 at Mux 416 and forwards them by wavelength to uplink Rxs 415, where Mux 416 and uplink Rxs 415 are substantially similar to Mux 316 and uplink Rxs 315, respectively.

It should be noted that in some embodiments, Mux 429, DL Rxs 425, OC 428, Mux 427, and PIRMs 421 are implemented in a TOR, and in some embodiments Mux 429, DL Rxs 425, OC 428, Mux 427, and PIRMs 421 are implemented in a single rack server 420 or distributed across a plurality of rack servers 420. Regardless of embodiment, by employing PIRMs 413 and 421, laser source 473 supplies enough optical carriers to allow for WDM communication between an EOR switch 411 and a plurality of rack servers 420 and also enough optical carriers for a plurality of EOR switches 470 and 411 to communicate with a plurality of corresponding rack servers 420. Such a system allows the EOR switches 411 and rack servers 420/TOR switches to be produced more cheaply by sharing lasers while still taking advantage of WDM optical communication.

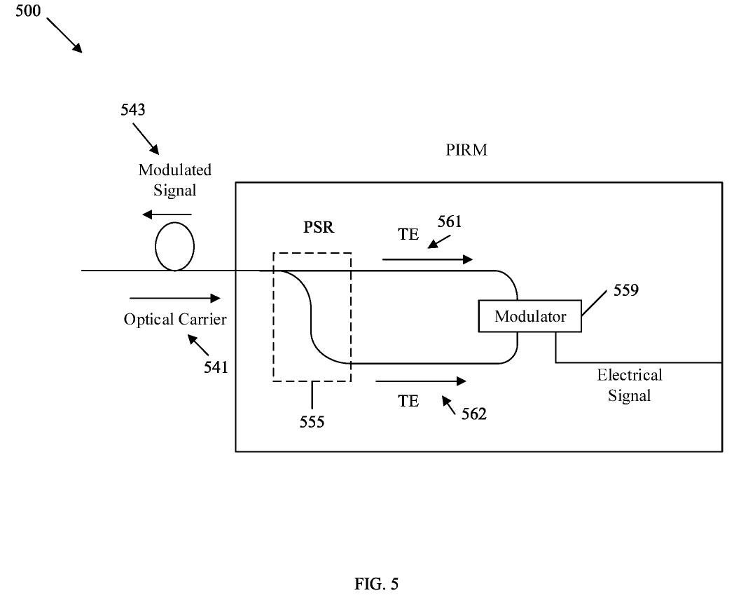

FIG. 5 is a schematic diagram of an embodiment of a silicon waveguide based PIRM 500. PIRM 500 is a specific embodiment of PIRM 100 and may be used as a PIRM in any systems disclosed herein, for example as PIRM 221, PIRM 321, PIRM 413, and/or PIRM 421. PIRM 500 is comprised of a silicon based substrate. PIRM 500 comprises a polarization splitter-rotator (PSR) 555, which serves a similar function to PBS 155 and PR 157. PSR 555 receives an optical carrier 541 from off-chip and splits the TE component 561 from the TM component such that the TE component 561 comprises a polarization that is perpendicular to the TM component. The PSR 555 then rotates the TM component into a TE polarization resulting in TE component 562 with the same/a parallel polarization to TE component 561. Modulator 559 is any silicon based modulator that is substantially similar to modulator 159, for example an MZM modulator, and IQ modulator, etc. Modulator 559 substantially simultaneously modulates TE component 561-562 with electrical data. The modulated TE component 561 exits the modulator 559 and continues along the light path in a clockwise fashion, while the modulated TE component 562 exits the modulator 559 and continues along the light path in a counter-clockwise manner. The two outputs (TE components 561-562) have orthogonal polarization, and the sum of the two output powers is independent to the polarization state of the incoming uplink carrier 541. The modulated TE components 561-562 are recombined at the PSR 555 into a single modulated optical signal 543 for transmission off-chip.

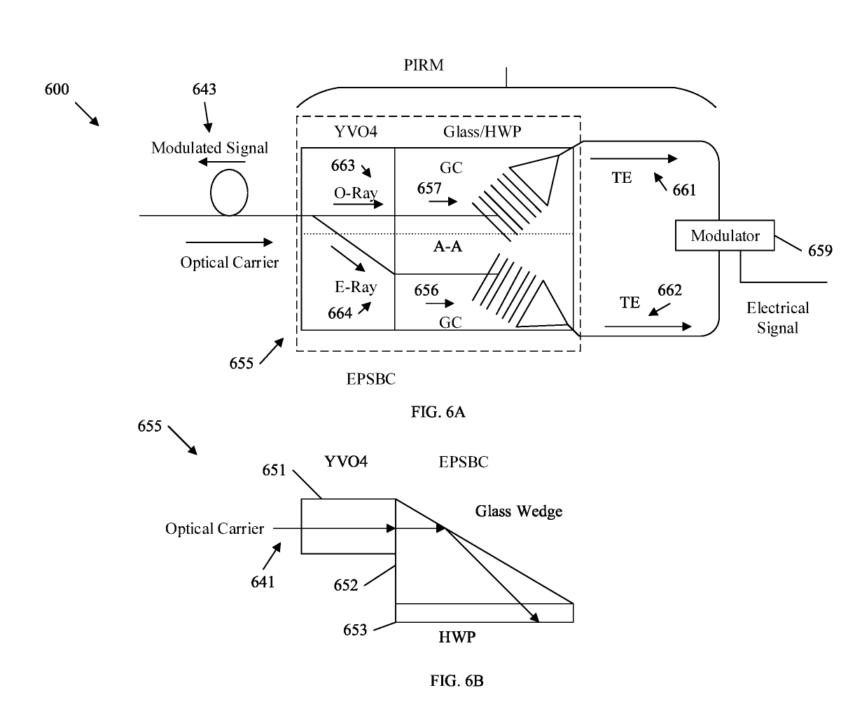

FIG. 6A is a top view of an embodiment of an external polarization beam splitter coupler (EPSBC) based PIRM 600. PIRM 600 is a specific embodiment of PIRM 100 and may be used as a PIRM in any system disclosed herein, for example as PIRM 221, PIRM 321, PIRM 413, and/or PIRM 421. PIRM 600 employs a PBS 655 comprising a birefringence crystal 651, a glass wedge 652, and a half wave plate (HWP) 653 as shown in FIG. 6B, which shows a side view of the EPSBC. The birefringence crystal 651, which may be made of Yttrium Orthovanadate (YVO₄) receives an optical uplink carrier 641 from off chip. The PIRM 600 may also comprise a lens (not shown) to focus the optical carrier 641 from the fiber to the birefringence crystal 651. The birefringence crystal 651 splits the optical carrier 641 into an ordinary ray (O-ray) 663, which has a polarization perpendicular to the page, and an extraordinary ray (E-ray) 664 which has a polarization that is perpendicular/orthogonal to the O-ray 663 (e.g., parallel to the page). The glass wedge 652 bends O-ray 663 and the E-ray 664 down to grating couplers (GCs) 657 and 656, respectively as shown in FIG. 6A. The HWP 653 is positioned between the glass wedge 652 and the GCs 656-657. The lower surface of the HWP 653 is attached and bonded to the surface of the silicon chip containing the GCs 656-657. The wedge reflects the O-ray 663 and E-ray 664 and makes their polarization orientation parallel to the TE mode of the waveguide in the silicon portion of the PIRM 600. The HWP 653 further rotates the polarizations of the O-ray 663 and E-ray 664, as reflected by the glass wedge 652, by about 45 degrees and aligns them with the orientation of the corresponding GCs 656-657, resulting in TE component 661 and TE component 662, respectively. As such, the PBS 655 provides substantially the same functionality as PBS 155 and PR 157. The GCs 656-657 are any photoresist gratings configured to couple light into a waveguide. Upon entering the GCs 656-657, TE components 661-662 enter light paths through the silicon waveguide. PIRM 600 further comprises a modulator 659, which is substantially similar to modulators 159 and 559. The TE components 661-662 enter the modulator 659 from a clockwise and a counter-clockwise direction, respectively, and are substantially simultaneously modulated, with an electrical signal being substantially simultaneously modulated onto the TE components 661-662. Modulated TE components 661-662 then return to the GCs 656-657, respectively, and are combined into an output signal 643 by the PBS 655 for transmission off chip (e.g. across a fiber).

FIG. 6B is a cross sectional view of the embodiment of the EPSBC based PIRM 600 taken across line A-A in FIG. 6A. As can be seen in FIG. 6A, the birefringence crystal splits the O-ray 663 and E-ray 664 in the horizontal plane. As shown in FIG. 6B, the glass wedge 652 refracts the O-ray 663 and E-ray 664 in the vertical plane and through the HWP 653 for entry in the GCs 656-657.

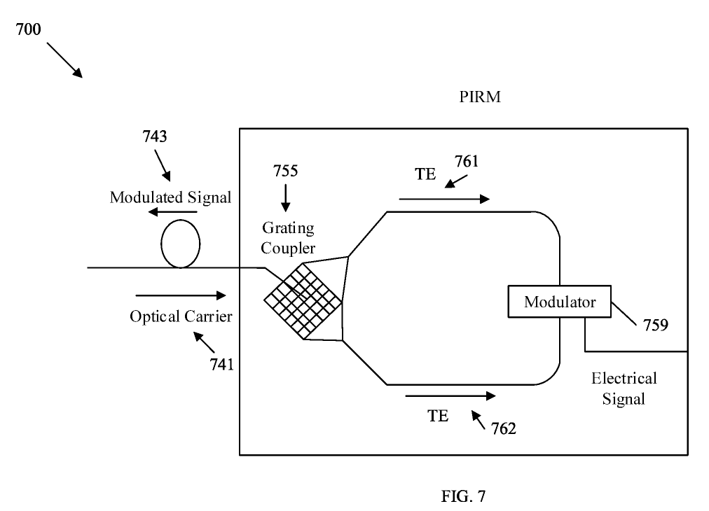

FIG. 7 is a schematic diagram of an embodiment of a grating coupler based PIRM 700. PIRM 700 is a specific embodiment of PIRM 100 and may be used as a PIRM in any system disclosed herein, for example as PIRM 221, PIRM 321, PIRM 413, and/or PIRM 421. PIRM 700 receives an optical carrier 741 from off chip. PIRM 700 comprises a two-dimension grating coupler 755 (2D-GC) with a specified incidence angle for the waveguide. The 2D-GC 755 has two gratings with corresponding orientations orthogonal to each other. Accordingly, the optical carrier 741 is split across the grating coupler 755 such that a first optical component is transmitted into the lower waveguide to become the TE component 762 while a second optical component with an orthogonal orientation is transmitted into the upper waveguide to become another TE component 761. As such, the grating coupler 755 performed substantially the same function as a PBS 155 and PR 157. PIRM 700 comprises a modulator 759, which is substantially similar to modulator 159, and is configured to substantially simultaneously modulate TE components 761-762. Modulated TE component 761 returns to the grating coupler 755 in a clockwise direction while modulated TE component 762 returns to the grating coupler 755 in a counter-clockwise direction. Modulated TE components 761-762 are then combined by the grating coupler 755 into a single output signal 743 for transmission off chip (e.g. across a fiber).

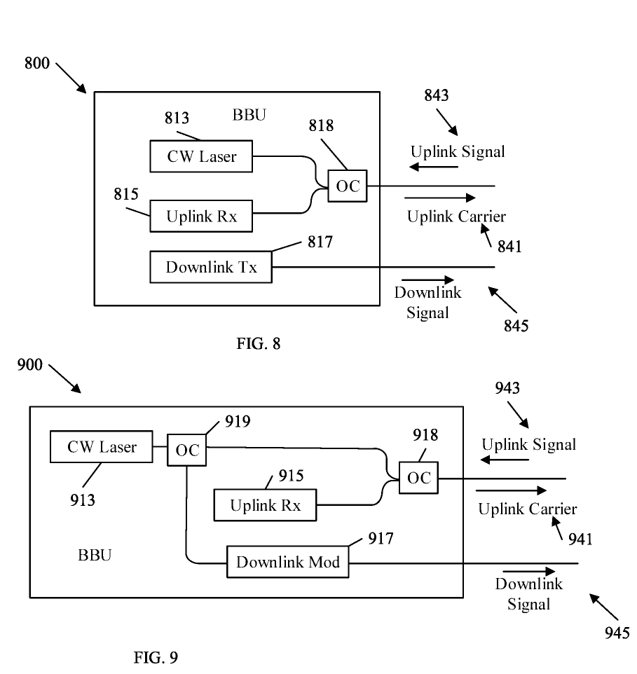

FIG. 8 is a schematic diagram of an embodiment of a baseband unit (BBU) 800 for use in a CRAN, such as CRAN 200, employing PIRMs, such as PIRMs 100, 221, 500, 600, and/or 700. For example, BBU 800 may implement one or more BBU transceivers 211. BBU 800 comprises a CW laser 813, and uplink Rx 815, and an OC 818, which are substantially similar to the CW laser 313, the uplink Rx 315, the OC 318, but are not configured for WDM. Specifically, the CW laser 813 generates a single uplink carrier 841 for downstream transmission to the RRU (e.g. RRU 220) via the OC 818, and a modulated uplink signal 843 is received back from the RRU via the same fiber. The OC 818 forwards the uplink signal 843 from the RRU into the uplink Rx 815 for conversion into electrical data. The BBU 800 further comprises a downlink Tx 817, which is a CW laser with a modulator, such as a modulator 159. The downlink Tx 817 creates and modulates an optical carrier, resulting in a downlink signal 845 for transmission to the RRU. Accordingly, BBU 800 employs two optical fibers, one for the uplink signal 843 and uplink carrier 841 and one for the downlink signal 845. Further, both lasers (e.g. laser 813 and downlink Tx 817) are positioned in the BBU 800 allowing the RRU to be produced without an on device laser/optical source, while still employing optical communication.

FIG. 9 is a schematic diagram of another embodiment of a BBU 900 for use in a CRAN, such as CRAN 200, employing PIRMs such as PIRMs 100, 221, 500, 600, and/or 700. For example, BBU 900 may implement one or more BBU transceivers 211. BBU 900 may be substantially similar to BBU 800 but may employ a single CW laser 913 for both upstream and downstream communications. BBU 900 comprises CW laser 913, uplink Rx 915, and OCs 918-919, which are substantially similar to CW laser 813, uplink Rx 815, and OC 818, respectively, but coupled in a different configuration. BBU 900 further comprises downlink modulator 917, which is substantially similar to downlink Tx 817, but does not comprise a laser/optical source. CW laser 913 transmits an optical carrier, which is split by OC 919 and forwarded to OC 918 as an uplink carrier 941 and forwarded to downlink modulator 917 as a downlink carrier. Downlink modulator 917 modulates the downlink carrier to create a downlink signal 945 for transmission to an RRU via a fiber. Uplink carrier 941 is forwarded downstream to an RRU, which modulates the uplink carrier 941 into an uplink signal 943 as discussed above. The uplink signal 943 is received by OC 918 and forwarded to uplink Rx 915 for conversion into electrical data. One or more optical amplifiers may be placed along the light paths as needed to boost the optical signal, for example between OC 918 and uplink Rx 915 and/or between OC 918 and the transmission fiber. Accordingly, BBU 900 employs two optical fibers, one for the uplink signal 943 and uplink carrier 941 and one for the downlink signal 945, but employs a single laser 913 per RRU. Further, the laser 913 is positioned in the BBU 900 allowing the RRU to be produced without an on-device laser/optical source, while still employing optical communication.

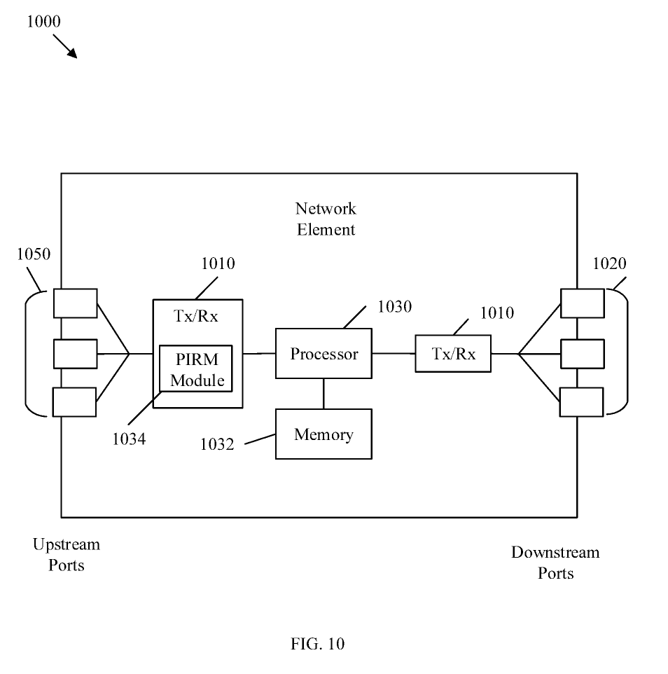

FIG. 10 is a schematic diagram of an embodiment of an NE 1000 configured to operate in a network, such as networks 200, 300, and/or 400, employing PIRMs, such as PIRMs 100, 500, 600, and/or 700. For example, the NE 1000 may be located in an optical transmission system, such as a CRAN or a datacenter network, and may comprise a Tx comprising a PIRM module 1034 (comprising a PIRM but not comprising a corresponding laser). The NE 1000 may be configured to implement or support any of the schemes described herein. In some embodiments NE 1000 may act as an RRU, BBU, EOR switch, TOR switch, rack server, or any other optical network element disclosed herein. One skilled in the art will recognize that the term transceiver unit encompasses a broad range of devices of which NE 1000 is merely an example. NE 1000 is included for purposes of clarity of discussion, but is in no way meant to limit the application of the present disclosure to a particular transceiver unit embodiment or class of transceiver unit embodiments. At least some of the features/methods described in the disclosure may be implemented in a network apparatus or component such as a NE 1000. For instance, the features/methods in the disclosure may be implemented using hardware, firmware, and/or software installed to run on hardware. The NE 1000 may be any device that transports electrical, wireless, and/or optical signals through a network, e.g., a switch, router, bridge, server, a client, etc. As shown in FIG. 10, the NE 1000 may comprise transceivers (Tx/Rx) 1010, which may be transmitters, receivers, or combinations thereof, comprising a PIRM. A Tx/Rx 1010 may be coupled to a plurality of upstream ports 1050 for transmitting and/or receiving optical frames from other nodes and a Tx/Rx 1010 coupled to a plurality of downstream ports 1020 for transmitting and/or receiving frames from other nodes, respectively. In some embodiments, the Tx/Rx 1010 is an antenna for use in downstream transmissions and downstream ports 1020 are omitted. A processor 1030 may be coupled to the Tx/Rxs 1010 to process the data signals and/or determine which nodes to send data signals to. The processor 1030 may comprise one or more multi-core processors and/or memory devices 1032, which may function as data stores, buffers, etc. Processor 1030 may be implemented as a general processor or may be part of one or more application specific integrated circuits (ASICs) and/or digital signal processors (DSPs). The NE 1000 may comprise a PIRM module 1034, which may be configured to modulate a received optical carrier to generate an optical signal for re-transmission as discussed herein. The downstream ports 1020 and/or upstream ports 1050 may contain electrical, wireless, and/or optical transmitting and/or receiving components.

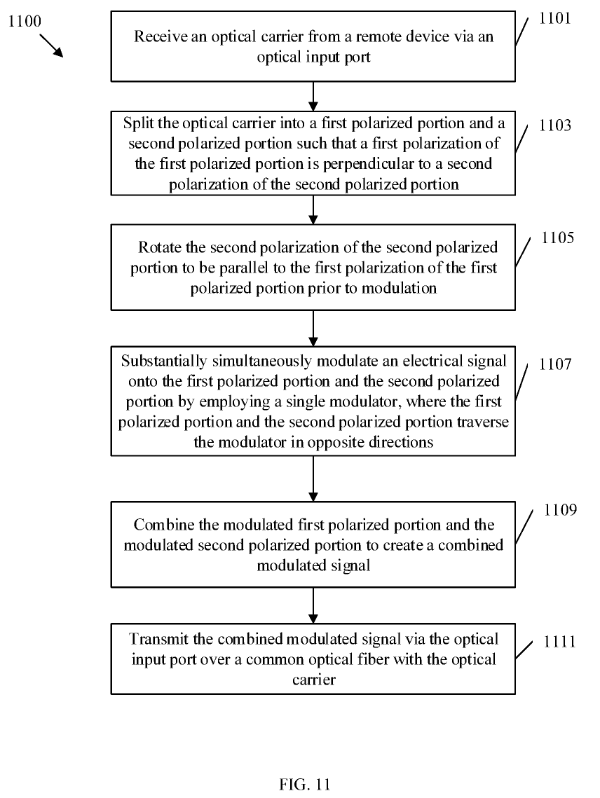

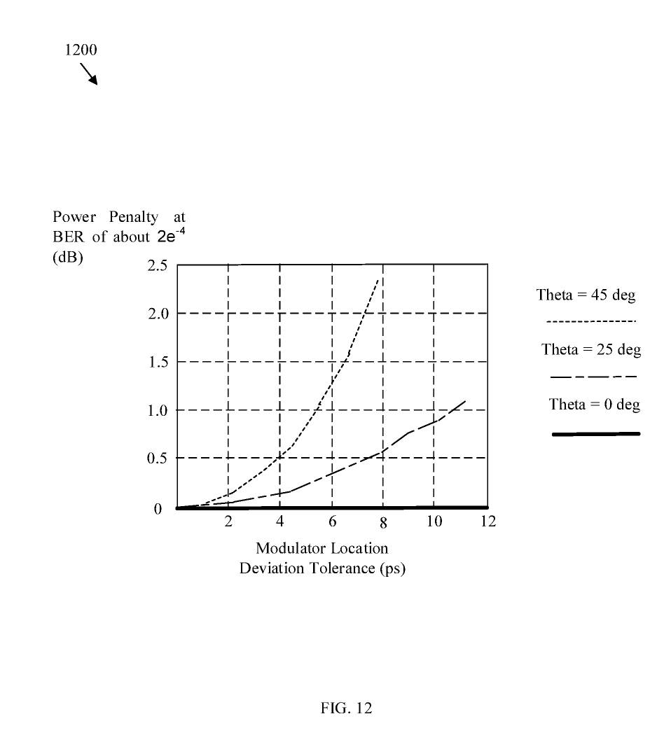

FIG. 11 is a flowchart of an embodiment of a method 1100 of PIRM based modulation, for example in a network such as networks 200, 300, and/or 400, employing PIRMs, such as PIRMs 100, 500, 600, and/or 700. Method 1100 is initiated when an optical carrier is received from a remote device. At step 1101, an optical carrier is received from a remote device via an optical input port. At step 1103, the optical carrier is split (by a polarization beam splitter/combiner) into a first polarized portion and a second polarized portion such that a first polarization of the first polarized portion is perpendicular (e.g. orthogonal) to a second polarization of the second polarized portion. By performing step 1103, the two polarizations of the optical carrier are separated and can be managed separately. At step 1105, the second polarization of the second polarized portion is rotated (e.g. by a polarization rotator) to be parallel to the first polarization of the first polarized portion prior to modulation. At step 1107, an electrical signal is substantially simultaneously modulated onto the first polarized portion and the second polarized portion by employing a single modulator. As discussed above, the first polarized portion and the second polarized portion traverse the modulator in opposite directions (e.g. clockwise and counter-clockwise). At step 1109, the modulated first polarized portion and the modulated second polarized portion are returned to the polarization beam splitter/combiner and combined to create a combined modulated signal. At step 1111, the combined modulated signal is transmitted via the optical input port over a common optical fiber with the optical carrier.

FIG. 12 is a graph 1200 of power penalty versus modulator location deviation tolerance for an embodiment of a PIRM, such as PIRMs 100, 221, 321, 413, 421, 500, 600, 700, and 1034. Graph 1200 shows the power penalty to achieve a bit error rate (BER) of 2e⁻⁴ as a function of modulator location tolerance for various polarization rotation angles θ relative to the TE polarization of a PBS. The worst performance is exhibited at θ=45 degrees. BER in graph 1200 is determined based on a Non-return-to-zero (NRZ) with a baud rate of 28 Gigabauds (Gbauds) per second (GBauds/s) and a transmitter and receiver bandwidth of about 0.75 times the baud rate. For modulator location tolerances less than 2 picosecond (ps), the penalty is very small for all the θ evaluated. For location tolerances of less the 1 ps, the power penalty to achieve the BER is negligible regardless of θ. Accordingly, so long as a PIRM is at a location within 1-2 ps of the light path center, the power penalty to achieve the desired BER is acceptable.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. An apparatus comprising:
an optical input configured to receive an optical carrier;
a polarization beam splitter optically coupled to the optical input, a first light path, and a second light path, wherein the polarization beam splitter is configured to:
forward a first polarized component of the optical carrier along the first light path; and
forward a second polarized component of the optical carrier along the second light path, wherein the first polarized component comprises a first polarization that is perpendicular to a second polarization of the second polarized component upon exiting the polarization beam splitter; and
an optical modulator with a proximate end coupled to the first light path and a distal end coupled to the second light path, wherein the optical modulator is configured to modulate the first polarized component of the optical carrier and the second polarized component of the optical carrier.

2. The apparatus of claim 1, wherein modulating the first polarized component and the second polarized component comprises:
receiving the first polarized component from the first light path via the proximate end;
receiving the second polarized component from the second light path via the distal end;
modulating the first polarized component to generate a first modulated component;
modulating the second polarized component to generate a second modulated component;
outputting the first modulated component to the second light path via the distal end; and
outputting the second modulated component to the first light path via the proximate end.

3. The apparatus of claim 2, wherein the polarization beam splitter is further configured to:
combine the first modulated component and the second modulated component into a combined modulated signal; and
forward the combined modulated signal via the optical input in an opposite direction to a direction of the optical carrier.

4. The apparatus of claim 3, wherein the first polarized component and the second polarized component are substantially simultaneously modulated by a common electrical signal.

5. The apparatus of claim 1, further comprising a polarization rotator positioned along the second light path and configured to rotate the second polarization of the second polarized component to be parallel to the first polarization of the first polarized component.

6. The apparatus of claim 5, wherein the polarization rotator comprises a Faraday rotator or mode convertor.

7. The apparatus of claim 5, wherein the first light path and the second light path comprise a silicon waveguide, and wherein the polarization beam splitter and the polarization rotator are comprised in a silicon based polarization splitter rotator (PSR).

8. The apparatus of claim 1, wherein the optical modulator comprises a silicon waveguide based modulator, a single lumped modulator, a Mach-Zehnder modulator, an Inphase Quadrature (IQ) modulator, a micro-ring resonator based modulator, an electro-absorption modulator, or combinations thereof.

9. The apparatus of claim 5, wherein the polarization beam splitter comprises a Yttrium Orthovanadate (YVO4) birefringence crystal, and wherein the polarization rotator comprises a glass wedge and a half wave plate.

10. The apparatus of claim 5, wherein the polarization beam splitter and the polarization rotator are comprised in a two-dimensional grating coupler.

11. An apparatus comprising:
an optical port configured to receive an optical carrier from a remote device;
a polarization independent reflective modulator (PIRM) coupled to the optical port, wherein the PIRM is configured to:
receive the optical carrier from the optical port;
split the optical carrier into a first polarized component and a second polarized component such that a first polarization of the first polarized component is perpendicular to a second polarization of the second polarized component;
modulate an electrical signal onto the first polarized component and the second polarized component; and
combine the modulated first polarized component and the modulated second polarized component to create a combined modulated signal.

12. The apparatus of claim 11, wherein the PIRM is further configured to rotate the second polarization to be parallel to the first polarization and substantially simultaneously modulate the first polarized component and the second polarized component.

13. The apparatus of claim 11, wherein the apparatus comprises a plurality of PIRMs, wherein the apparatus further comprises a wavelength division multiplexer coupled to the optical port and the PIRMs, wherein the optical carriers comprises a plurality of wavelengths, and wherein the wavelength division multiplexer is configured to distribute each wavelength to a corresponding PIRM to support wavelength division multiplexing.

14. The apparatus of claim 11, wherein the apparatus is a server positioned in a data center, wherein the remote device is an end-of-row (EOR) switch, and wherein the PIRM is further configured to transmit the combined modulated signal to the EOR switch via the optical port.

15. The apparatus of claim 11, wherein the apparatus further comprises a downstream optical port, and wherein the PIRM is further configured to transmit the combined modulated signal to a downstream device via the downstream optical port.

16. The apparatus of claim 11, wherein the apparatus is a remote radio unit (RRU), wherein the remote device is a baseband unit (BBU), wherein the apparatus comprises a wireless transceiver, and wherein the electrical signal is received from a mobile network via the wireless transceiver for modulation and re-transmission to the BBU via the optical port.

17. A method comprising:
receiving an optical carrier from a remote device via an optical input port;
splitting the optical carrier into a first polarized component and a second polarized component such that a first polarization of the first polarized component is perpendicular to a second polarization of the second polarized component;
modulating an electrical signal onto the first polarized component and the second polarized component; and
combining the modulated first polarized component and the modulated second polarized component to create a combined modulated signal.

18. The method of claim 17, further comprising transmitting the combined modulated signal via the optical input port over a common optical fiber with the optical carrier.

19. The method of claim 18, further comprising rotating the second polarization of the second polarized component to be parallel to the first polarization of the first polarized component prior to modulation.

20. The method of claim 19, wherein the electrical signal is substantially simultaneously modulated onto the first polarized component and the second polarized component by employing a single modulator, and wherein the first polarized component and the second polarized component traverse the single modulator in opposite directions.
